(19) United States
(12) Patent Application Publication
(10) Pub. No.: US 2024/0008508 A1
(43) Pub. Date: Jan. 11, 2024

(54) TEXTURED LEGUME PROTEINS

(71) Applicant: ROQUETTE FRERES, Lestrem (FR)

(72) Inventors: Cyril DROULEZ, LESTREM (FR); Christophe LAROCHE, FOUGERES (FR); Mathias IBERT, LA CHAPELLE D'ARMENTIERES (FR)

(21) Appl. No.: 18/255,040

(22) PCT Filed: Dec. 1, 2021
(86) PCT No.: PCT/EP2021/025480

§ 371 Date: May 30, 2023

(30) Foreign Application Priority Data
Dec. 1, 2020 (FR) 2012493

(51) Int. Cl. A23J 3/26; A23J 3/14

(52) U.S. Cl. CPC A23J 3/26; A23J 3/14

(57) ABSTRACT

The invention relates to a method for obtaining a composition comprising textured legume proteins, while optimizing energy and water consumption, and also to the products obtained and the use thereof.

### PRIOR ART

The present invention relates to a method for manufacturing a composition comprising textured pea proteins, as well as to said composition comprising textured pea proteins and the industrial uses thereof.

The technique for texturing proteins, especially by extrusion cooking, with the aim of preparing products with a fibrous structure intended for producing meat and fish analogs, has been applied to numerous plant sources.

The extrusion cooking processes for proteins can be separated into two large families by the amount of water used in the process. When this amount is greater than 30% by weight, this will be referred to as “wet” extrusion cooking, and the products obtained will be more intended for producing finished products for immediate consumption that simulate animal meat, for example, beef steaks or chicken nuggets. When this amount of water is less than 30% by weight, this is then referred to as “dry” extrusion cooking: the products obtained are more intended to be used by food-processing manufacturers, in order to formulate meat substitutes by mixing them with other ingredients.

Historically, the first proteins used for these meat substitute production methods were extracted from soybean and wheat. Soybean subsequently quickly became the main source for this field of applications.

While most of the studies that followed obviously related to soybean proteins, other sources of protein, both animal and plant, have been textured: peanut, sesame, cottonseed, sunflower, corn, wheat proteins, proteins derived from microorganisms, by-products from abattoirs or the fisheries industry.

Legume proteins, such as those derived from pea and faba bean, have also been the subject of work, both in terms of the isolation thereof and in terms of the “dry” or “wet” extrusion cooking thereof.

Numerous studies have been undertaken on legume proteins, in particular pea proteins, given their particular functional and nutritional properties but also because of their non-genetically-modified nature.

Despite significant research efforts and increasing growth over recent years, the penetration of these products based on textured proteins on the food market is still subject to optimization.

One of the reasons in particular lies in the sometimes high cost of legume protein isolates, in particular for pea proteins. In fact, in order to obtain them, the person skilled in the art must carry out several steps, usually concluding in a drying step. This last step contributes a non-negligible fraction of the final price of the isolate. A solution to lower costs consists of using a protein concentrate. Such concentrates are produced via a process (known under the names of turbo-separation or air-classification) exclusively carried out in a dry medium, without the addition of water. In this case, although the production cost is indeed reduced, the low protein content of a concentrate (less than 60%-70% for dry) limits the final applications and the nutritional value of the product.

It should be noted in the thesis “Texturization of pea protein isolates using high moisture extrusion cooking” (Osen, 2017) that the quality of the protein used in feeding the extruder is an essential parameter in this quest to optimize that method, in particular from a cost point of view. FIG. 68 of that document shows us the impact of different commercial protein isolates on the Specific Mechanical Energy (SME) expressed in KJ/Kg. This SME makes it possible to quantify and compare the energy to be supplied to the extrusion system (extruder and mixture to be extruded) in order to texture the proteins. The higher the SME, the more energy the system requires, and the higher the cost and wear of the equipment. It can be seen clearly in this FIG. 68 that during wet extrusion, whose parameters are similar in all respects (temperature, pressure, humidity, etc.), the use of the isolate from the company EMSLAND (denoted PPI2 in the thesis) leads to energy overconsumption (about 0.5 to 1.5 times the SME of the two other isolates). This PPI2 isolate differs from the other two isolates, respectively derived from the companies ROQUETTE and COSUCRA, in that it is in a more native state, that is, with a protein whose three-dimensional shape is similar to that which it had within the seed, as demonstrated in chapter 4.1, and in particular chapter 4.1.3 where a DSC study clearly demonstrates this native state. It was therefore known to a person skilled in the art that a protein in a more native state was counterproductive to this effort to limit energy consumption, because it led to a much higher SME for the same result.

It is to the applicant's credit to have resolved the above problems and to have developed a method integrating the production of a wet floc of pea globulins, which by definition have not undergone any drying step, followed by extrusion cooking.

This invention will be better understood in the following section which aims to disclose a general description thereof.

### General Description of the Present Invention

The present invention relates to a method for producing a plant protein composition comprising the following steps:
1) Providing a wet composition comprising plant proteins, preferentially legume proteins, wherein at least 30% by dry weight of the dry mass of total proteins has undergone no drying step during its extraction process.

2) Texturing the composition from step 1 by extrusion cooking.

Preferably, the legumes implemented in the method in step 1 according to the invention are selected from the list containing pea or faba bean, even more preferentially pea protein.

Preferably, step 2 of the method according to the invention is carried out by extrusion cooking in an extruder, preferentially a twin-screw extruder.

The present invention also relates to a composition comprising textured legume proteins capable of being obtained by a production method according to the invention

Preferably, the protein content within the composition ranges between 60% and 80%, preferentially between 70% and 80% by dry weight relative to the total weight of dry matter of the composition.

Finally, the present invention relates to the use of the composition of textured legume proteins according to the invention as described above in industrial applications such as, for example, the human and animal food industry, industrial pharmaceuticals or cosmetics.

The present invention will be better understood upon reading the following detailed description.

### DETAILED DESCRIPTION OF THE PRESENT INVENTION

The present invention relates to a method for producing a plant protein composition characterized comprising the following steps:
1) Providing a wet composition comprising plant proteins, preferentially legume proteins, wherein at least 30% by dry percentage of the mass of total proteins 30 has undergone no drying step during its extraction process.
2) Texturing the composition from step 1 by extrusion cooking

The first step therefore consists of providing a wet composition comprising plant proteins, at least 30% of which by dry weight of the dry mass of total proteins has undergone no drying step during its extraction process.

Preferably, the plant protein, preferentially a legume protein, is selected from the list made up of faba bean protein and pea protein. Pea protein is particularly preferred.

The term “leguminous” is considered herein to mean the family of dicotyledonous plants of the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The production of plant proteins can be carried out starting from any suitable material (seeds, flours, etc.) and by any means known to a person skilled in the art when the method does not comprise any drying step for at least 30% by dry weight of the dry mass of total proteins of the composition.

“Drying” will be understood in this patent application to mean any unitary engineering step of chemical and/or food processes aimed at partially or completely removing the water molecules from a composition. For example, a person skilled in the art knows for this purpose rotating dryers, atomizers, fluidized bed dryers, infrared tunnels, lyophilizers. This list is not exhaustive.

Preferably, the plant proteins obtained without drying in order to supply the method according to the invention have at most a dry matter content of 50%. It is important for the invention that said proteins retain a native state, without undergoing denaturation caused by a drying step. In the previously cited 2017 thesis by Osen, the PPI2 isolate is certainly in a more native state than the other two isolates but it is a commercial isolate in powder form, meaning that it has undergone a drying step. It may be assumed that such a protein is therefore a mixture of native and non-native proteins.

Preferably, plant proteins, preferentially legume proteins, which have not undergone any drying step during their extraction processes represent at least 35% by dry weight of the dry mass of total proteins. It will be preferred that this percentage is gradually greater than 40%, 45%, 50%, 55%, 60%, 65%, 70%, 75%, 80%, 85%, 90% or even 95% by dry weight of the dry mass of total proteins. Supplying the extruder with 100% legume proteins by dry weight relative to the dry mass of total proteins, which had undergone no drying step during their extraction process, is also conceivable, although it is technically complicated. This is because proteins that have not undergone any drying step have a high viscosity, in particular if they represents more than 50% of the total proteins provided to supply the extruder, making it difficult to feed them into the extruder. It would be interesting in the future to work and solve this technical problem in order to allow industrial-scale production. The amount will vary according to the desired final product as well as the constituents added in addition to the proteins. The core of the invention lies in that at least 30% by dry weight of the proteins relative to the dry weight of the total proteins did not undergo any drying step during their extraction process.

In the final preferred embodiment, the extruder is supplied with between 30% and 50% legume proteins by dry weight relative to the dry mass of total proteins that had not undergone any drying step during their extraction process

In a preferred embodiment, the method making it possible to produce a legume protein composition without drying in order to supply the method according to the invention comprises the following steps:
a) providing legume seeds or flour, preferentially selected from pea and faba bean;
b) milling and making an aqueous suspension;
c) separating out insoluble fractions using centrifugal force;
d) coagulating the proteins at isoelectrical pH, optionally heating of the protein solution without causing an increase in the dry matter above 50 wt %;
e) collecting the coagulated protein floc by centrifugation.

The method thus starts with a step a) of providing legume seeds or flour, preferentially selected from pea and faba bean;

The seeds used in step a may have been previously subjected to steps that are well known to those skilled in the art, such as especially cleaning (removal of undesired particles such as stones, dead insects, soil residues, etc.) or even the removal of the external fibers of the peas (external cellulose hull) through a well-known step referred to as “dehulling”.

Treatments for improving the organoleptic properties such as dry heating (or roasting) or wet bleaching are also possible. For bleaching, the temperature is preferentially between 70° C.±2° C. and 80° C.±2° C. and the pH is adjusted to between 8±0.5 and 10±0.5, preferentially to 9±0.5. These conditions are maintained for 2 to 4 min, preferentially for 3 min. These treatments are in no way intended to cause the drying of the material, but rather to inhibit the various enzymes such as lipoxygenases.

The method according to the invention comprises a step 2) of milling the flour and/or seeds and producing an aqueous suspension.

This milling step is necessary for the seed and optional for the flour.

If the seeds are already in the presence of water, the water is retained but may also be renewed, and the seeds are directly milled. If the seeds are dry, a meal is first produced, and it is then suspended in water.

The milling is performed by any type of suitable technology known to those skilled in the art, such as with ball mills, conical mills, helical mills, jet mills or rotor/rotor systems.

During milling, water may be added in a continuous or discontinuous manner, at the start, during or at the end of milling, so as to produce at the end of the step an aqueous suspension of milled peas with between 15% and 25% by weight of solids (SC), preferentially 20% by weight of SC, relative to the weight of said suspension.

At the end of milling, the pH can be checked. Preferably, the pH of the aqueous suspension of milled peas at the end of step b) is adjusted to between ±0.5 and 10±0.5, preferentially the pH is adjusted to 9±0.5. The pH may be adjusted by adding acid and/or base, for example sodium hydroxide or hydrochloric acid.

The preferred method then consists of a step c) of separating out the insoluble fractions using a centrifugal force. These fractions consist mainly of starch and of polysaccharides called “internal fibers”. The proteins soluble in the supernatant are thus concentrated.

The preferred method comprises a step d) of coagulating the proteins at isoelectrical pH, optionally heating of the protein solution without causing an increase in the dry matter above 50% by weight.

If heating is applied in addition to coagulation at the isoelectric pH, it will preferentially be applied with a temperature of between 55° C.±2° C. and 75° C.±2° C., preferentially between 60° C. and 70° C.±2° C., for a time comprised between 1 min and 5 min, preferentially between 2 min and 4 min, even more preferentially 3 min.

The purpose of this step d) here is to separate the pea proteins of interest from the other constituents of the supernatant from step c). Such a process example is described, for instance, in EP1400537 of the Applicant, from paragraph 127 to paragraph 143. It is essential to better control the time/temperature in order not to denature the protein.

The following step e) consists of collecting the coagulated protein floc by centrifugation. The solid fractions with concentrated proteins are thus separated from the liquid fractions with concentrated sugars and salts. The floc thus obtained can be directly used in supplying the extruder or may undergo optional steps

The floc may thereby be resuspended in water and its pH is adjusted to a value of between 6±0.5 and 9±0.5. The solids content is adjusted to between 10% and 20%, preferentially 15% by weight of solids relative to the weight of said suspension. The pH is adjusted using any acidic and basic reagent(s). The use of ascorbic acid, citric acid, potassium hydroxide and sodium hydroxide, is preferred.

The legume protein composition without drying may thus be the single input feeding the extruder, but it may also be added to different constituents.

Preferably, a plant fiber, preferentially a legume fiber, may be added. “Leguminous fiber” is understood to mean any compositions comprising polysaccharides that are relatively indigestible or indigestible by the human digestive system, extracted from leguminous plants. Such fibers are extracted using any method that is well known to a person skilled in the art. A commercial example of such a fiber is for example Pea Fiber I 50M (containing 50% by weight minimum of internal pea fibers, 10% by maximum weight of pea proteins and about 35% by weight of pea starch) from the company Roquette.

The legume fiber is preferably selected from the list made up of faba bean protein and pea protein. Pea protein is particularly preferred.

The mixture fed into the extruder can essentially consist of legume proteins and legume fibers. The term “essentially consist of” means that the powder can comprise impurities associated with the method for producing the proteins and the fibers, for example, traces of starch.

The dry weight ratio between proteins and fibers is advantageously between 70/30 and 90/10, preferentially between 75/25 and 85/15.

The mixing can be carried out upstream or even directly when being fed into the extruder. During this mixing, additives can be added that are well known to a person skilled in the art, such as flavorings or even dyes.

In an alternative preferred embodiment, a plant fiber, preferentially a legume fiber, may be added. The addition of such a quantity of proteins makes it possible both to increase the quantity of extruded protein but can also improve the nutritional quality. On that matter, the measured addition of another protein source to that of the legume protein composition will be carried out without drying in order to improve the PDCAAS of the textured protein produced.

PDCAAS (Protein Digestibility Corrected Amino Acid Score) is an index that is used to evaluate the quality of the proteins as a function of the human amino acid and protein digestibility requirements. The method for calculating PDCAAS is based on comparing a standard amino acid profile having the best possible score (1 or 100%), with the amino acid profile of the food being studied. The PDCAAS is evaluated on a scale of 0 to 1 (1 designating the best quality and 0 the least good).

For any embodiment of the invention, well-known food processing components can be added, for example water, dyes, flavorings, gelling agents, stabilizers, and antioxidants.

In the present invention, “water” is understood to mean water that can be drunk or used for domestic and industrial purposes without posing health risks. Preferably, it will be understood that this water has a sulfate content of less than 250 mg/I, a chloride content of less than 200 mg/I, a potassium content of less than 12 mg/I, a pH ranging between 6.5 and 9 and a total hardness (TH, namely the hardness of the water, corresponding to the measurement of the calcium and magnesium ions content in water) of more than 15 French degrees. In other words, drinking water must not have less than 60 mg/I of calcium or 36 mg/I of magnesium.

“Flavorings” is understood in the present invention to mean any chemical compound making it possible to modify the perception of taste and smell, which together form what is known as “flavor”. European legislation, as defined by Regulation 1334/20082, understands flavorings to be “products not intended to be consumed as such, which are added to food in order to impart or modify odor and/or taste” (Article 3.a of Regulation EC 1334/2008).

Flavorings are derived from or consist of the following components: flavoring substances, flavoring preparations, smoke flavorings, thermal process flavorings, flavor precursors and other flavorings.

In the context of the present invention, flavoring is preferentially understood to mean a flavoring substance. A flavoring substance is a “defined chemical substance with flavoring properties” (definition in Article 3.b of Regulation EC 1334/2008).

A natural flavoring substance is “obtained by appropriate physical, enzymatic or microbiological processes, from material of vegetable, animal or microbiological origin either in the raw state or after processing for human consumption by one or more of the traditional food preparation processes listed in Annex II of Regulation EC 1334/2008” (Article 3.c of Regulation EC 1334/2008).

Natural flavoring substances correspond to substances that are naturally present and have been identified in nature. The flavoring substances can also be derived from natural sources other than the “raw” natural source, it is then a matter of synthesizing the molecule and reproducing it. Other molecules, that have not been identified in nature, can also have a more powerful taste than natural molecules.

A particular case of flavoring substance will be the generating of compounds resulting from the Maillard reaction. This chemical reaction between reducing compounds such as sugars and amine compounds such as proteins generates colored and odorizing compounds.

“Dyes” means any type of compound, or even combination of compounds, having the ability to modify the color of another compound (or even mixture of compounds) due to its introduction.

The dye can itself provide its functionality. These dyes will be of any type such as natural dyes (such as the concentrates and/or extracts of fruits and vegetables) or artificial dyes. In the context of our invention, particularly interesting dyes can be selected, including but not limited to: beet betaine, tomato lycopene, pepper extract (paprika), caramel. Indeed, these red and/or brown dyes make it possible to quite easily imitate the color of red meat.

The coloration can also be generated during extrusion by chemical reaction with a protein compound. Here again, the Maillard reaction can be cited again, as well as the use of iron salts.

The protein content of the composition feeding the method according to the invention advantageously ranges between 60% and 80%, preferentially between 70% and 80% by weight relative to the total dry matter. Any method well known to a person skilled in the art can be used to analyze this protein content. Preferably, the total nitrogen amount will be assayed and this content will be multiplied by the coefficient 6.25. This method is particularly known and used for plant proteins.

The second step of the method according to the invention consists of texturing the composition of step 1 by extrusion cooking. During that step, this mixture of powders will then be textured, which is the same as saying that the proteins will undergo thermal destructuring and reorganization in order to form fibers with continuous elongation in straight, parallel lines, simulating the fibers present in meats. Any method well known to a person skilled in the art will be suitable, in particular extrusion.

“Textured” or “texturing” in the present application is understood to mean any physical and/or chemical process that aims to modify a composition comprising proteins in order to give it a specific ordered structure. Within the scope of the invention, texturing proteins aims to give the appearance of a fiber, such as those present in animal meats.

Extrusion consists in forcing a product to flow through a small hole, the die, under the action of high pressures and shearing forces, using the rotation of one or two Archimedes screws. The resulting heating causes cooking and/or denaturing of the product, hence the term sometimes used, “extrusion cooking”, then expansion by evaporation of the water at the die outlet. This technique makes it possible to develop products which are widely varied in their composition, their structure (expanded and alveolar form of the product), and their functional and nutritional properties (denaturing of anti-nutritional or toxic factors, sterilization of food, for example). Processing of proteins often leads to structural modifications which are reflected by obtaining products with a fibrous appearance, simulating animal meat fibers.

In general, step 2 can be carried out with a water/dry matter mass ratio in the extruder that can be between 15% and 70%.

More preferentially, the water/dry matter mass ratio in the extruder will be between 40% and 70%, even more preferentially between 50% and 65%. This ratio is obtained by analyzing the mixture entering the extruder.

Without being bound by any theory, it is well known to a person skilled in the art of extrusion cooking that it is this preferential ratio that will allow the required quality of the final product to be obtained, in terms of texture, organoleptic quality, or appearance. The values of this ratio therefore will potentially be 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70%.

Preferably, step 2 is carried out by extrusion cooking in an extruder, preferentially a twin-screw extruder, characterized by a length/diameter ratio of between 35 and 65, preferentially 40 and 65, even more preferentially 60, and equipped with a succession of conveying elements, kneading elements, and reverse pitch elements which will be selected by a person skilled in the art to ensure good extrusion, based on his conventional knowledge of the field.

The length to diameter ratio is a conventional parameter in extrusion cooking. This ratio therefore can be 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65.

The various elements are the feeding elements intended for feeding the product into the die without modifying the product, the kneading elements intended for mixing the product and the reverse pitch elements intended for applying a force to the product to cause it to advance in the opposite direction and thus cause mixing and shearing.

Even more preferably, a specific power ranging between 10 and 25 kWh/kg is applied to the powder mixture, by regulating the pressure at the outlet in a range ranging between 10 and 25 bars, preferentially between 12 and 16 bars.

Even more preferably, the outlet of the twin-screw extruder consists of an outlet die with orifices opening onto a cutter. Such an installation is particularly suitable for producing an expansion of the mixture at the outlet. The products thus obtained will for example be dry textured proteins or crisps.

To specify this embodiment, the orifices will preferentially be 1.5 mm in diameter and the cutter adjusted with a rotational speed of between 2000 and 2400 revolutions per minute, preferentially 2200 rpm.

In a preferred alternative, the extruder outlet consists of a cooled die in order to limit the expansion. The extruded wet strip will be cut, stored and/or implemented in the form of meat or fish analogs.

To specify this embodiment, the die described at the preceding point may consist of one or more modules equipped with cooling circuits. The cooling of the die is in the majority of cases carried out in the direction opposite the flow of material coming from the extruder. Temperature control can be carried out using thermoregulators by applying temperatures between 10 and 95° C.

In all the embodiments described, it will be possible to carry out post-production steps such as, in a non-exhaustive manner, grinding, marinading, drying, freezing, deep-freezing, brining, and adsorption of dyes and/or flavorings.

In a preferred embodiment, a marinade of dyes and flavorings will be applied in order to impregnate the composition of textured legume proteins followed by drying. This succession of steps can thus be used to obtain a plant “jerky”, a North American specialty of dried, salted beef, cut into thin strips.

In an even more preferred embodiment, the textured legume protein composition will be ground, added to different compounds including flavorings and dyes, then molded into a patty shape.

The present invention also relates to the composition comprising textured legume proteins capable of being obtained by the method according to the invention

In a particular embodiment, the composition according to the invention has a protein content between 60% and 80%, preferentially between 70% and 80% by dry weight relative to the total weight of dry matter of the composition.

Finally, the present invention relates to the use of the composition of textured legume proteins according to the invention or able to be obtained by the method according to the invention in industrial applications such as, for example, the human and animal food industry, industrial pharmaceuticals or cosmetics.

The invention will be of particular interest in the field of analogs of meat, fish, sauces, soups.

Preferably, a particular application relates to the use of the composition according to the invention for manufacturing meat analogues, in particular minced meat analogues. Other options are bolognese sauce, hamburger patties, meat for tacos and pitas, and “chili sin came”.

In pizzas, the texture composition according to the invention will be of particular interest for being sprinkled on top of said pizza (as a “topping”).

The human and animal food industry is also understood to include industrial confectionery (for example, chocolate, caramel, jelly sweets), bakery products (for example, bread, brioches, muffins), the meat and fish industry (for example, sausages, hamburgers, fish nuggets, chicken nuggets), sauces (for example, bolognese, mayonnaise), products derived from milk (for example, cheese, plant milk), beverages (for example, high protein beverages, powdered beverages to be reconstituted).

According to a particular embodiment, the present invention also relates to the use of the textured legume proteins composition according to the invention or capable of being obtained by the method according to the invention in the production of textured proteins by extrusion intended for the fields of animal and/or human food.

The invention will be better understood upon reading the following non-limiting examples.

### EXAMPLES

### Example 1: Production of a Composition of Textured Legume Proteins in a Wet Process Outside of the Invention

A powder mixture is produced consisting of 100% of NUTRALYS® F85M pea protein (comprising 87.2% by dry weight of proteins relative to the total weight) from the company ROQUETTE.

This mixture is introduced by gravity into a LEISTRITZ ZSE 27MAXX extruder from Leistriz of motor power equal to 33.8 kW and whose maximum achievable rotational speed is 1200 rpm.

The mixture is introduced with a regulated flow rate of 11 to 13 kg/h. 15.07 kg/h of water is also introduced. The humidity in the extruder is about 60%.

The extrusion screw is composed of conveying elements, kneading elements and reverse pitch elements organized according to the following profile detailed in Table 1 below:

TABLE 1

| Elements | Name of screw elements | Type of screw elements |
|---|---|---|
| 1 | GFA-2-20-30 (start) | conveying |
| 2 | GFF-2-40-30-A | conveying |
| 3 | GFF-2-40-30-M | conveying |
| 4 | GFF-2-40-30-M | conveying |
| 5 | GFF-2-40-30-M | conveying |
| 6 | GFF-2-40-30-M | conveying |
| 7 | GFF-2-40-30-M | conveying |
| 8 | GFF-2-40-30-E | conveying |
| 9 | GFA-2-40-30 | conveying |
| 10 | GFA-2-40-30 | conveying |
| 11 | GFA-2-40-30 | conveying |
| 12 | GFA-2-40-30 | conveying |
| 13 | GFA-2-40-30 | conveying |
| 14 | GFA-2-40-30 | conveying |
| 15 | GFA-2-40-30 | conveying |
| 16 | GFA-2-40-30 | conveying |
| 17 | GFA-2-30-30 | conveying |
| 18 | GFA-2-30-30 | conveying |
| 19 | GFA-2-30-30 | conveying |
| 20 | GFA-2-40-30 | conveying |
| 21 | GFA-2-40-30 | conveying |
| 22 | GFA-2-40-30 | conveying |
| 23 | GFA-2-30-30 | conveying |
| 24 | KB-4-2-15-90 | kneading |
| 25 | KB-4-2-15-90 | kneading |
| 26 | GFA-2-40-30 | conveying |
| 27 | GFA-2-30-30 | conveying |
| 28 | GFA-2-30-30 | conveying |
| 29 | GFA-2-30-30 | conveying |
| 30 | GFA-2-20-30 | conveying |
| 31 | KB-4-2-15-30 | kneading |
| 32 | KB-4-2-15-90 | kneading |
| 33 | GFA-2-20-30-L | Reverse |
| 34 | GFA-2-40-30 | conveying |
| 35 | GFA-2-40-30 | conveying |
| 36 | GFA-2-30-30 | conveying |
| 37 | KB-4-2-15-90 | kneading |
| 38 | KB-4-2-15-90 | kneading |
| 39 | GFA-2-40-30 | conveying |
| 40 | GFA-2-40-30 | conveying |
| 41 | GFA-2-30-30 | conveying |
| 42 | GFA-2-20-30 | conveying |
| 43 | KB-4-2-15-90 | kneading |
| 44 | KB-4-2-15-90 | kneading |
| 45 | GFA-2-20-30-L | Reverse |
| 46 | GFA-2-20-30 | conveying |
| 47 | GFA-2-40-30 | conveying |
| 48 | GFA-2-40-30 | conveying |
| 49 | GFA-2-20-30 | conveying |
| 50 | KB-4-2-15-30 | kneading |
| 51 | KB-4-2-15-90 | kneading |
| 52 | GFA-2-40-30 | conveying |
| 53 | GFA-2-30-30 | conveying |
| 54 | GFA-2-30-30 | conveying |
| 55 | GFA-2-20-30 | conveying |
| 56 | KB-4-2-15-90 | kneading |
| 57 | KB-4-2-15-90 | kneading |
| 58 | GFA-2-30-30 | conveying |
| 59 | GFA-2-20-30 | conveying |
| 60 | GFA-2-20-30 | conveying |
| 61 | GFA-2-20-30 | conveying |

This extrusion screw is rotated at a speed equal to 350 rpm and sends the mixture into a die. Two temperature profiles detailed below in Table 2 (in degrees Celsius) are employed, using 15 tubes located around the extruder and which can be heated:

TABLE 2

| | Z15 | Z14 | Z13 | Z12 | Z11 | Z10 | Z9 | Z8 | Z7 | Z6 | Z5 | Z4 | Z3 | Z2 | Z1 |
|---|---|---|---|---|---|---|---|---|---|---|---|---|---|---|---|
| T° C. | 120 | 120 | 130 | 150 | 150 | 130 | 100 | 90 | 80 | 60 | 60 | 60 | 35 | 35 | x |
| profile | | | | | | | | | | | | | | | |
| #1 | | | | | | | | | | | | | | | |
| T° C. | 90 | 120 | 120 | 120 | 115 | 115 | 120 | 110 | 60 | 60 | 60 | 60 | 35 | 35 | x |
| profile | | | | | | | | | | | | | | | |
| #2 | | | | | | | | | | | | | | | |

The product is directed at the outlet to a thermally controlled die, FDK750 model from the brand Coperion, comprising two modules with a length of 80 cm and a passage cross-section 50 mm×15 mm, the second module of which being thermally controlled to 30° C.

The textured protein thus produced is cut at the outlet of the die into 10 cm strips.

The torque is raised during extrusion (and the average torque and its standard deviation are calculated) and the SME is calculated using the formula below (expressed in kWh/Kg):

$$\\ \begin{matrix}SME ( kWh / kg ) = \frac{\begin{matrix}yield coeff \times motor P max ( kW ) \times \\ torque ( \% ) \times screw speed used ( rpm )\end{matrix}}{\begin{matrix}yield coeff \times motor P max ( kW ) \times \\ torque ( \% ) \times screw speed used ( rpm )\end{matrix}} . & Math . 1\end{matrix}$$

TABLE 3

| Data | Origin | Value |
|---|---|---|
| Yield coeff | Equipment technical data | 0.97 |
| Motor P max (kW) | Equipment technical data | 33.8 |
| Max screw speed (rpm) | Equipment technical data | 1200 |
| Torque (%) | Read during the tests | See summary table |
| Screw speed used | Test variable | 350 (or see |
| (rpm) | | summary table) |
| Total flow rate | Test variable | See summary table |

Table 4 below summarizes the various tests carried out: Two with temperature profile 1 and two with temperature profile 2

TABLE 4

| | Test 1 | Test 1′ | Test 2 | Test 2′ |
|---|---|---|---|---|
| | T° C. | T° C. | T° C. | T° C. |
| | profile | profile | profile | profile |
| Ref. | #1 | #1 | #2 | #2 |
| F85M flow rate (kg/h) | 13.48 | 11.13 | 13.48 | 11.13 |
| Water flow rate (kg/h) | 15.07 | 15.07 | 15.07 | 15.07 |
| Total flow rate (kg/h) | 28.55 | 26.2 | 28.55 | 26.2 |
| Mean SME (kWh/kg) | 5.157 | 4.164 | 5.236 | 4.17 |
| SME standard deviation | 0.563 | 0.623 | 0.439 | 0.457 |
| (kWh/kg) | | | | |
| Screw speed (rpm) | 350 | 350 | 350 | 350 |
| Humidity in extruder as % | 56.1 | 60.5 | 56.1 | 60.5 |
| T° profile | 1 | 1 | 2 | 2 |
| Average Torque as % | 15.398 | 11.409 | 15.634 | 11.426 |
| Torque standard deviation | 1.747 | 1.758 | 1.361 | 1.298 |

### Example 2: Production of a Composition of Textured Legume Proteins in a Dry Process According to the Invention

After dehulling the external fibers using a hammer mill, the pea seeds are milled to produce a meal. This meal is then soaked in water to a final concentration of 25% by weight of solids relative to the weight of said suspension, at a pH of 6.5, for 30 minutes at room temperature. The meal suspension at 25% by weight of solids is then introduced into a series of hydrocyclones, which separate a light phase consisting of a mixture of proteins, internal fibers (pulps) and soluble matter and a heavy phase, containing the starch. The light phase at the outlet of the hydrocyclones is then adjusted to a solids content of 10.7% relative to the weight of said suspension. The separation of the internal fibers is performed by treatment in centrifugal decanters of WESTFALIA type. The light phase at the outlet of the centrifugal decanter contains a mixture of proteins and of solubles, while the heavy phase contains the pea fibers.

The proteins are coagulated at their isoelectric point by adjusting the light phase at the outlet of the centrifugal decanter to a pH of 4.6 and heating this solution at 60° C. for 4 min. After coagulation of the proteins, a protein floc is obtained.

The floc thus obtained contains 24.28% dry matter and 75.72% water. It is introduced by gravity into a LEISTRITZ ZSE 27MAXX extruder from Leistriz of motor power equal to 33.8 kW and whose maximum achievable rotational speed is 1200 rpm, at a flow rate of 20.4 kg/h.

A powder mixture is also introduced consisting of 100% of NUTRALYS® F85M pea protein (comprising 87.2% by dry weight of proteins relative to the total weight) from the company ROQUETTE with a controlled flow rate between 5 and 8 kg/h. The humidity in the extruder is between 56 and 60%.

The extrusion screw is similar to that described in the preceding example. This extrusion screw is rotated at a speed equal to 350 rpm and sends the mixture into a die. Just like the preceding example, two temperature profiles described in Table 5 below (in degrees Celsius) are used:

TABLE 5

| | Z15 | Z14 | Z13 | Z12 | Z11 | Z10 | Z9 | Z8 | Z7 | Z6 | Z5 | Z4 | Z3 | Z2 | Z1 |
|---|---|---|---|---|---|---|---|---|---|---|---|---|---|---|---|
| T° C. | 120 | 120 | 130 | 150 | 150 | 130 | 100 | 90 | 80 | 60 | 60 | 60 | 35 | 35 | x |
| profile | | | | | | | | | | | | | | | |
| #1 | | | | | | | | | | | | | | | |
| T° C. | 90 | 120 | 120 | 120 | 115 | 115 | 120 | 110 | 60 | 60 | 60 | 60 | 35 | 35 | x |
| profile | | | | | | | | | | | | | | | |
| #2 | | | | | | | | | | | | | | | |

The product is directed at the outlet to a thermally controlled die, FDK750 model from the brand Coperion, comprising two modules with a length of 80 cm and a passage cross-section 50 mm×15 mm, the second module of which being thermally controlled to 30° C.

The textured protein thus produced is cut at the outlet of the die into 10 cm strips.

The torque is raised during extrusion (and the average torque and its standard deviation are calculated) and the SME is calculated using the formula below (expressed in kWh/Kg):

$$\\ \begin{matrix}SME ( kWh / kg ) = \frac{\begin{matrix}yield coeff \times motor P max ( kW ) \times \\ torque ( \% ) \times screw speed used ( rpm )\end{matrix}}{\begin{matrix}maximum screw speed ( rpm ) \times \\ total flow rate ( kg / h )\end{matrix}} . & Math . 2\end{matrix}$$

TABLE 6

| Data | Origin | Value |
|---|---|---|
| Yield coeff | Equipment technical data | 0.97 |
| Motor P max (kW) | Equipment technical data | 33.8 |
| Max screw speed | Equipment technical data | 1200 |
| (rpm) | | |
| Torque (%) | Read during the tests | See summary table |
| Screw speed used | Test variable | 350 (or see |
| (rpm) | | summary table) |
| Total flow rate | Test variable | See summary table |

Table 7 below summarizes the various tests carried out: Two with temperature profile 1 and two with temperature profile 2

TABLE 7

| | Test 1 | Test 1′ | Test 2 | Test 2′ |
|---|---|---|---|---|
| | T° C. | T° C. | T° C. | T° C. |
| | profile | profile | profile | profile |
| Ref. | #1 | #1 | #2 | #2 |
| F85M flow rate (kg/h) | 8.15 | 5.8 | 8.15 | 5.8 |
| Floc flow rate (kg/h) | 20.4 | 20.4 | 20.4 | 20.4 |
| Total flow rate (kg/h) | 28.55 | 26.2 | 28.55 | 26.2 |
| Mean SME (kWh/kg) | 4.356 | 3.18 | 5.079 | 3.53 |
| SME Gain (kWh/kg) | 15.53 | 23.63 | 3.00 | 15.35 |
| Screw speed (rpm) | 350 | 350 | 350 | 350 |
| Humidity in extruder as % | 56.1 | 60.5 | 56.1 | 60.5 |
| T° profile | 1 | 1 | 2 | 2 |
| Average Torque as % | 13.004 | 9.495 | 15.163 | 10.539 |
| Standard deviation | 1.179 | 0.456 | 1.262 | 0.766 |
| Gain in torque, floc vs. | 15.55 | 16.78 | 3.01 | 7.76 |
| wet extrusion (%) | | | | |

It is therefore observed that the method according to the invention enables:
A reduction of 3% to 17% in the torque required. This gain allows non-negligible energy savings, with the SME reduction being between 3 and 23%
15 kg/h estimated water saved, combined with saving energy on drying the isolate
The products are macroscopically of similar quality

### Example 3: Extrusion of a Pea-Fiber-and-Protein Mixture According to the Invention and Outside the Invention

The two extrusions carried out according to example 1 (outside the invention) and example 2 (according to the invention) are reproduced by modifying only what is supplied to the extruder

This feed is modified by replacing 8% of the weight of proteins by 8% of I 50M pea fibers (from the company ROQUETTE)

The synthesis of the parameters of the various tests is summarized in the following table:

| | outside the | | according to the | |
|---|---|---|---|---|
| | invention | | invention (floc) | |
| | | 92% | | 92% |
| Supply blend | 100% | protein + | 100% | protein + |
| composition | protein | 8% fiber | protein | 8% fiber |
| Floc flow rate (kg/h) | 0 | 0 | 19.4 | 21.8 |
| Powder flow rate | 12.7 | 14.56 | 7.7 | 9.1 |
| (kg/h) | | | | |
| Water flow rate (kg/h) | 14.4 | 16.34 | 0 | 0 |
| Total flow rate (kg/h) | 27.1 | 30.9 | 27.1 | 30.9 |
| Screw speed (rpm) | 350 | 350 | 350 | 350 |
| Humidity in extruder | 56.1 | 56.1 | 56.1 | 56.1 |
| as % | | | | |
| T° profile | Inter- | Inter- | Inter- | Inter- |
| | mediate | mediate | mediate | mediate |
| Pressure average | 29.1 | 34.7 | 17 | 20.9 |
| Average Torque as % | 16.1 | 13.6 | 11.4 | 10.31 |
| Torque standard | 0.6 | 0.4 | 0.57 | 0.69 |
| deviation | | | | |
| Variation in % of the | | | −41.23% | −31.91% |
| torque between the | | | | |
| floc and the wet | | | | |
| extrusion | | | | |

Here, the advantage of the method according to the invention is that the mixture to be extruded is either 100% protein, or more complex, for example a protein and pea fiber mixture

1. A method for producing a plant protein composition comprising the following steps:
1) providing a wet composition comprising plant proteins, preferentially legume proteins, wherein at least 30% by dry weight of the dry mass of total proteins has undergone no drying step during its extraction process; and,
2) texturing the composition from step 1 by extrusion cooking.

2. The method according to claim 1, wherein the wet composition comprising plant proteins, preferentially legume proteins, contains between 30% and 50% legume proteins by dry weight of the dry mass of total proteins, which have not undergone any drying step during their extraction process

3. The method according to claim 1, wherein the plant proteins which have not undergone any drying step are prepared using the following method:
a) using legume seeds or flour;
b) milling and making an aqueous suspension;
c) separating out insoluble fractions using centrifugal force;
d) coagulating the proteins at isoelectrical pH, optionally heating of the protein solution without causing an increase in the dry matter above 50 wt %; and,
e) collecting the coagulated protein floc by centrifugation.

4. The method according to claim 1, wherein the legumes are selected from the list containing pea and faba bean, even more preferentially pea.

5. The method according to claim 1, wherein step 2 is carried out by extrusion cooking in an extruder, preferentially a twin-screw extruder.

6. A composition comprising textured legume proteins capable of being obtained by the production method according to claim 1.

7. The composition according to claim 6, wherein the content within the composition ranges between 60% and 80%, preferentially between 70% and 80% by dry weight relative to the total weight of dry matter of the composition.

8. A use of the textured legume protein composition according to claim 6 or capable of being obtained by a production method having the steps of:
1) providing a wet composition comprising plant proteins, preferentially legume proteins, wherein at least 30% by dry weight of the dry mass of total proteins has undergone no drying step during its extraction process; and,
2) texturing the composition from step 1 by extrusion cooking,
in industrial applications such as the human and animal food industry or industrial pharmaceuticals or cosmetics.

9. The use according to claim 8, wherein the industrial application is the production of meat analogs, fish analogs.

10. The use according to claim 8, wherein the industrial application is the production of sauces, soups.

11. The use according to claim 8, wherein the industrial application is the production of proteins textured by extrusion for the fields of animal and/or human food.
